(19) United States
(12) Patent Application Publication
(10) Pub. No.: US 2015/0132182 A1
(43) Pub. Date: May 14, 2015

(54) ALUMINUM ALLOY HAVING HIGH ELECTRICAL CONDUCTIVITY

(71) Applicant: NEXANS, Paris (FR)

(72) Inventor: Emilien Comoret, Rouvray (FR)

(21) Appl. No.: 14/496,162

(22) Filed: Sep. 25, 2014

(30) Foreign Application Priority Data
Sep. 27, 2013 (FR) FR 13 59367

(51) Int. Cl. H01B 1/02; H01B 13/00

(52) U.S. Cl. CPC H01B 1/023; H01B 13/0006; H01B 13/0016
USPC 420/538; 420/529; 420/528; 148/552; 420/550

(57) ABSTRACT

An electrical cable (100A, 100B, 100C) has an elongate electrically conductive element (10A, 10B, 10C) made of aluminum alloy having aluminum (Al) and erbium precipitates (Al₃Er), where the aluminum alloy additionally has an element chosen from iron (Fe), copper (Cu) and a mixture thereof; and unavoidable impurities.

### RELATED APPLICATION

This application claims the benefit of priority to French Patent Application No. 13 59367, filed on Sep. 27, 2013, the entirety of which is incorporated by reference.

### BACKGROUND

1. Field of the Invention

The present invention relates to an electrical cable comprising an elongate electrically conductive element made of aluminum alloy, and also to a process for manufacturing said alloy and to a process for manufacturing said cable.

It typically, but not exclusively, relates to high-voltage electric power transmission cables or overhead power transmission cables better known as overhead line (OHL) cables.

2. Description of Related Art

These cables are conventionally composed of a central reinforcing element, surrounded by at least one electrically conductive layer.

The central reinforcing element may be a composite or metallic element. By way of example, mention may be made of steel strands or composite strands of aluminum in an organic matrix.

The electrically conductive layer may itself typically comprise an assembly of metallic strands, preferably twisted around the central element. The metallic strands may be strands made of aluminum, copper, an aluminum alloy or a copper alloy. As such, the electrically conductive layer is generally manufactured based on aluminum or on an aluminum alloy, since this material has quite a low weight with respect to other electrically conductive materials.

An aluminum alloy used as an electrical conductor, the hardness of which is improved, is known from document CN 101418401. Said alloy is composed of 0.01 to 0.40% by weight of erbium (Er), the remainder of the alloy being solely pure aluminum (Al). This alloy of aluminum and erbium (i.e. Al—Er alloy) is obtained by a process comprising a step of casting the molten Al—Er alloy, then one or more hot extrusion steps, then one or more annealing steps at a temperature of around 420° C. for 50 hours, and finally a cold-drawing step, in order to obtain Al—Er alloy wires having a diameter of 4 mm. However, this Al—Er alloy has the drawback of having a reduced electrical conductivity with respect to pure aluminum. Furthermore, the process for manufacturing said Al—Er alloy, and in particular the hot-extrusion and annealing steps, do not make it possible, on the one hand to control the microstructure of the erbium precipitates (Al₃Er), and on the other hand to produce enough erbium precipitates in said alloy. Therefore, this process leads to a reduction of the breaking strength and of the electrical conductivity of said alloy.

### OBJECTS AND SUMMARY

The objective of the present invention is to overcome the drawbacks of the techniques from the prior art by proposing an aluminum alloy, in particular used as an elongate electrically conductive element in an electrical cable, comprising aluminum and erbium, that is easy to manufacture, and has improved electrical properties, while guaranteeing good mechanical properties.

One subject of the present invention is an electrical cable, especially of OHL type, comprising an elongate electrically conductive element made of aluminum alloy comprising aluminum (Al) and erbium precipitates (Al₃Er), characterized in that said aluminum alloy additionally comprises an element chosen from iron (Fe), copper (Cu) and a mixture thereof; and unavoidable impurities.

Owing to the presence of the erbium precipitates (Al₃Er) and of at least one of the elements selected from copper, iron and a mixture of iron and copper, the aluminum alloy of the electrical cable of the invention has good mechanical properties, especially in terms of hot creep resistance and breaking strength, and good electrical properties, especially in terms of conductivity. Specifically, the presence of iron and/or copper promotes the precipitation of the erbium, and thus the increase in the electrical conductivity.

According to one particular embodiment, the erbium precipitates (Al₃Er) have a mean size strictly smaller than 1 μm approximately, and preferably strictly smaller than 0.5 μm approximately.

According to one particularly preferred embodiment of the invention, the erbium precipitates (Al₃Er) have a mean size ranging from 1 to 100 nm approximately, and preferably ranging from 2 nm to 50 nm approximately.

According to one particular embodiment, the erbium precipitates (Al₃Er) present in the aluminum alloy are spherical.

In one particular embodiment, the electrical cable may additionally comprise an elongate reinforcing element.

In the present invention, the presence of an elongate reinforcing element makes it possible in particular to form an overhead power transmission cable (i.e. OHL cable).

Preferably, the elongate reinforcing element is surrounded by said electrically conductive element, the elongate reinforcing element being in particular a central element.

According to one preferred embodiment of the invention, the aluminum alloy comprises iron (Fe) and optionally copper (Cu), and more preferably iron (Fe) and copper (Cu).

The amount of erbium in the aluminum alloy of the invention may be advantageously at least 100 ppm by weight. When the amount of erbium is less than 100 ppm by weight, the aluminum alloy may not comprise enough erbium precipitates to retain a good electrical conductivity. Furthermore, the small amount of erbium (i.e. less than 100 ppm) may be trapped by the iron, when the latter is present, leading to a degradation of the mechanical and electrical properties of said alloy.

The amount of erbium in the aluminum alloy of the invention may be advantageously at most 10 000 ppm by weight. Beyond 10 000 ppm by weight of erbium, the electrical conductivity of the alloy may drop significantly, especially due to the fact of too great an agglomeration of the erbium precipitates in said alloy.

Particularly advantageously, the aluminum alloy of the invention may comprise from 250 ppm to 5000 ppm by weight of erbium, and preferably from 800 to 4000 ppm by weight of erbium.

In the present invention, the abbreviation “ppm” stands for “parts per million by weight”. In other words, the content in ppm of an element is expressed with respect to the total weight of the alloy.

The presence of iron in the aluminum alloy of the invention makes it possible to improve the mechanical properties with respect to the breaking strength, while maintaining a good electrical conductivity.

The aluminum alloy of the invention may comprise at least 1000 ppm by weight of iron, preferably from 1500 ppm to 4000 ppm by weight of iron, and more preferably from 2500 ppm to 3500 ppm by weight of iron.

The presence of copper in the aluminum alloy of the invention makes it possible to improve the mechanical properties with respect to the hot creep resistance, while maintaining a good electrical conductivity. An alloy that has a good hot creep resistance withstands deformation under long-term mechanical stresses at high temperatures.

The aluminum alloy of the invention may comprise from 500 ppm to 3500 ppm by weight of copper, preferably from 1200 ppm to 2200 ppm by weight of copper.

According to one preferred embodiment, the aluminum alloy of the invention may comprise from 1500 ppm to 4000 ppm by weight of iron and from 500 ppm to 3500 ppm by weight of copper, and preferably from 2500 ppm to 3500 ppm by weight of iron and from 1200 ppm to 2200 ppm by weight of copper.

Owing to the present invention, the aluminum alloy of the electrical cable has both good electrical properties and good mechanical properties.

Indeed, the erbium present in the aluminum alloy of the invention combines in particular with the iron and/or with the copper and/or with the unavoidable impurities in order to “purify” the aluminum alloy and thus to increase its electrical conductivity up to 5% IACS, or even more.

The electrical conductivity of the aluminum alloy of the invention may be at least 59% IACS (International Annealed Copper Standard), preferably at least 61% IACS, and preferably at least 62% IACS.

It is preferable for the aluminum alloy of the invention to comprise only aluminum; erbium; an element chosen from iron, copper and a mixture thereof; and unavoidable impurities. Indeed, if other elements are added to the alloy, the electrical conductivity may drop greatly. For electrical applications, it is important to keep the aluminum alloy as pure as possible.

The aluminum content of the alloy of the invention may be at least 95.00% by weight, preferably at least 98.00% by weight, preferably at least 99.00% by weight, preferably at least 99.50% by weight, and preferably at least 99.70% by weight.

The content of unavoidable impurities in the aluminum alloy according to the invention may be at most 1.50% by weight, preferably at most 1.10% by weight, preferably at most 0.60% by weight, preferably at most 0.30% by weight, and preferably at most 0.10% by weight.

In the present invention, the expression “unavoidable impurities” is understood to mean the sum of the metallic or non-metallic elements included in the alloy, apart from aluminum, erbium, iron, copper, and possibly oxygen, during the manufacture of said alloy.

These unavoidable impurities may be, for example, one or more of the following elements: Ag, Cd, Cr, Mg, Mn, Pb, Si, Ti, V, Ni, S and/or Zn.

These unavoidable impurities may also be Y (yttrium) or Zr (zirconium).

Within the context of the invention, the elongate electrically conductive element may be one or more metallic strands made of aluminum alloy of the invention.

Particularly preferably, the elongate electrically conductive element may comprise an assembly of metallic strands made of aluminum alloy. This assembly may especially form at least one layer of continuous envelope type, for example having a circular or oval or else square cross section.

When the electric cable of the invention comprises an elongate reinforcing element, said assembly may be positioned around the elongate reinforcing element.

The metallic strands may be of round, trapezoidal or Z-shaped cross section.

When the strands are of round cross section, they may have a diameter that may range from 2.25 mm to 4.75 mm. When the strands have a cross section that is not round, their diameter equivalent to a round cross section may also range from 2.25 mm to 4.75 mm.

Of course, it is preferable for all the constituent strands of an assembly to have the same shape and the same dimensions.

In one preferred embodiment of the invention, the elongate reinforcing element is surrounded by at least one layer of an assembly of metallic strands made of aluminum alloy of the invention.

Preferably, the constituent metallic strands of at least one layer of an assembly of metallic strands made of aluminum alloy of the invention are capable of giving said layer a substantially uniform surface, it being possible for each constituent strand of the layer in particular to have a cross section of shape that is complementary to the strand(s) that is/are adjacent thereto.

According to the invention, the expression “metallic strands capable of giving said layer a substantially uniform surface, it being possible for each constituent strand of the layer in particular to have a cross section of shape that is complementary to the strand(s) that is/are adjacent thereto” is understood to mean that: the juxtaposition or interlocking of all of the constituent strands of the layer, forms a continuous envelope (without irregularities), for example of circular or oval or else square cross section.

Thus, the strands of Z-shaped or trapezoidal-shaped cross section make it possible to obtain a uniform envelope unlike the strands of round cross section. In particular, strands of Z-shaped cross section are preferred.

More preferably still, said layer formed by the assembly of metallic strands has a ring-shaped cross section.

The elongate reinforcing element may be typically a composite or metallic element. By way of example, mention may be made of steel strands or of composite strands of aluminum in an organic matrix.

The elongate electrically conductive element of the invention may be twisted around the elongate reinforcing element, especially when said elongate electrically conductive element is an assembly of metallic strands.

Another subject of the invention is a process for manufacturing an aluminum alloy comprising aluminum and erbium precipitates (Al₃Er), especially for the use thereof as an elongate electrically conductive element for an electrical cable, said process comprising the following steps:

i. forming a molten aluminum alloy comprising aluminum (Al); erbium (Er) (the erbium not being in the form of precipitates); unavoidable impurities; and optionally an element chosen from iron, copper and a mixture thereof;

ii. casting the molten alloy from step i, in order to obtain an as-cast alloy; said process being characterized in that it additionally comprises the following steps:

iii. rolling the as-cast alloy from step ii, in order to obtain a rolled alloy; and

iv. heating the rolled alloy from step iii, in order to form erbium precipitates (Al₃Er).

The inventors of the present application have discovered surprisingly that the electrical conductivity of the alloy obtained at the end of the heating step iv is increased. Thus, owing to the process of the invention, and especially owing to the heating step iv, sufficient erbium precipitates are formed to enable the increase of the electrical conductivity with respect to an alloy that does not contain erbium. Moreover, the addition of iron and/or copper to the alloy, combined with the rolling step iii and heating step iv of the process of the invention result in an alloy that has both improved mechanical properties, especially in terms of hot creep resistance and breaking strength, and a better electrical conductivity.

The erbium precipitates (Al₃Er) formed during step iv of the process of the invention are “secondary” precipitates that must be differentiated from “primary” erbium precipitates that may optionally be formed after a casting step. These primary precipitates are very coarse (i.e. they have a mean size ranging from 0.5 to 10 μm) and not spherical unlike the secondary precipitates. The primary precipitates do not make it possible to form an alloy that has a good conductivity. Only step iv makes it possible to form secondary erbium precipitates, the latter having suitable size and shape for improving the electrical properties of the alloy of the invention.

Step i may be conventionally carried out by incorporating a master alloy comprising aluminum; erbium; iron and/or copper; into a bath of substantially pure molten aluminum.

Step ii makes it possible in particular to form, by cooling (i.e. solidification) of the as-cast, an as-cast aluminum alloy, in particular in the form of a bar. The cross section of the bar may range for example from 500 mm² to 2500 mm², or even more.

In one particular embodiment, the casting step ii is carried out at a temperature ranging from 670° C. to 850° C. approximately, and preferably from 710° C. to 780° C. approximately.

By way of example, the casting step may be carried out continuously, in particular using a rotating “casting” wheel.

The cooling (i.e. solidification of the as-cast) is preferably carried out suddenly, especially by passing from a temperature of 670° C.-850° C. approximately to a temperature of 150° C. approximately in a few minutes, i.e. in 1 to 15 minutes approximately, and preferably in 1 to 5 minutes approximately.

Owing to this very rapid cooling, the formation of primary precipitates is avoided or limited. Thus, following step ii, an aluminum phase is obtained with erbium at the sites of the aluminum without formation, or with a limited formation, of primary erbium precipitates.

Step iii makes it possible to roll said as-cast aluminum alloy in order to obtain a rolled alloy.

The casting step ii and rolling step iii make it possible to control the microstructure of the erbium precipitates in said alloy by avoiding the formation of coarse erbium precipitates (i.e. primary precipitates), and thus guarantee that an aluminum alloy is obtained that has good mechanical properties, especially in terms of breaking strength.

Said rolled alloy has a cross section that is preferably round. The diameter of the cross section may range for example from 7 mm to 26 mm approximately.

In one particular embodiment, the rolling step iii may be carried out hot, in particular at a temperature ranging from 300° C. to 450° C. approximately.

Step iv of heating the rolled alloy makes it possible itself to control the microstructure of the erbium precipitates in said alloy (i.e. formation of secondary precipitates) and also to form sufficient erbium precipitates.

Furthermore, during said step iv, the erbium may combine in particular with the iron and/or with the copper and/or with the unavoidable impurities in order to “purify” the aluminum alloy of the invention and thus to increase its electrical conductivity up to 5% IACS, or even more.

According to one particular embodiment, the erbium precipitates (Al₃Er) have a mean size strictly smaller than 1 μm approximately, and preferably strictly smaller than 0.5 μm approximately.

According to one particularly preferred embodiment of the invention, the erbium precipitates (Al₃Er) obtained at the end of step iv have a mean size ranging from 1 to 100 nm approximately, and preferably ranging from 2 nm to 50 nm approximately.

According to one particular embodiment, the erbium precipitates (Al₃Er) present in the aluminum alloy are spherical.

In one particular embodiment, this step iv makes it possible to obtain at least 80 parts by weight of erbium in the form of precipitates per 100 parts by weight of erbium in the aluminum alloy manufactured according to the process of the invention, and preferably at least 90 parts by weight of erbium in the form of precipitates per 100 parts by weight of erbium in the aluminum alloy manufactured according to the process of the invention.

This step iv may preferably be a “tempering” step well known to a person skilled in the art.

In one particular embodiment, step iv is carried out at a temperature ranging from 150° C. to 450° C. approximately, and preferably from 300° C. to 400° C. approximately.

In one preferred embodiment, the duration of the heating step iv ranges from 10 minutes to 48 hours approximately, and preferably from 10 hours to 18 hours approximately.

In one even more preferred embodiment, the heating according to step iv may be carried out using an electric furnace and/or an induction furnace and/or a gas furnace.

According to one particular embodiment, the process for manufacturing the aluminum alloy of the invention may comprise, after step iv, the following step:

v. cold-working the heated alloy from step iv, in order to obtain a cold-worked alloy.

The cold-working step v may preferably be a drawing step, and makes it possible in particular to obtain metallic strands (or wires) of aluminum alloy, in particular of round or trapezoidal or a Z-shaped cross section. The diameter of the cross section may range from 0.2 mm to 5.0 mm.

According to one particular embodiment, the process for manufacturing the aluminum alloy of the invention may comprise, after step v, the following step:

vi. heating the alloy from step v, in order to increase the mechanical elongation of the alloy.

This step vi may preferably be an “annealing” step.

In one particular embodiment, step vi is carried out at a temperature ranging from 200° C. to 400° C.

In one particular embodiment, the duration of the heating step vi ranges from 30 minutes to 10 hours approximately.

The purpose of the heating step vi is to soften the cold-worked alloy from step v, that is to say to eliminate a portion of the deformation caused in particular by the drawing step v, without modifying the microstructure of the erbium precipitates obtained at the end of step iv.

In one particular embodiment, step vi may result in an aluminum alloy having an elongation at break of at most 30%, and preferably of at most 5%.

The process for manufacturing the aluminum alloy of the invention is a process that is easy to implement. Furthermore, it makes it possible to obtain an alloy having both good electrical properties and good mechanical properties.

Moreover, it avoids one or more restrictive extrusion and annealing steps, which may lead to a degradation of the mechanical properties of the alloy (i.e. degradation of the ultimate tensile strength or of the breaking strength).

The aluminum alloy described in the process above may be that as described in the electrical cable of the invention.

According to one preferred embodiment of the invention, the aluminum alloy described in the process above comprises iron (Fe) and optionally copper (Cu), and more preferably iron (Fe) and copper (Cu).

Another subject of the invention is an aluminum alloy obtained according to the process for manufacturing an aluminum alloy comprising aluminum and erbium precipitates as defined above.

Said aluminum alloy, obtained from the process for manufacturing an aluminum alloy comprising aluminum and erbium (the erbium not being in the form of precipitates), may comprise at least 80 parts by weight of erbium in the form of precipitates per 100 parts by weight of erbium in said alloy, and preferably at least 90 parts by weight of erbium in the form of precipitates per 100 parts by weight of erbium in said alloy. Owing to its high content of erbium precipitates, the aluminum alloy has improved electrical properties.

Another subject of the invention is a process for manufacturing the electrical cable as described in the invention, said process comprising the following steps:

a. manufacturing an elongate electrically conductive element made of aluminum alloy according to said manufacturing process mentioned above, and

b. positioning said elongate electrically conductive element made of aluminum alloy obtained in step a, around the elongate reinforcing element, in order to form the electrical cable.

More particularly, when the elongate electrically conductive element is an assembly of metallic strands of aluminum alloy, step a consists in obtaining said metallic strands, and step b consists in positioning the metallic strands around the reinforcing element, so as to form at least one layer of said metallic strands around said reinforcing element. Preferably, the metallic strands are twisted around said reinforcing element.

In one particular embodiment, in the layer formed around said reinforcing element, each metallic strand has a cross section of shape that is complementary to the strand(s) that is/are adjacent thereto, and that is capable of giving said layer a substantially uniform surface.

### BRIEF DESCRIPTION OF DRAWINGS

Other features and advantages of the present invention will appear in light of the following examples with reference to the annotated figures, said examples and figures being given by way of illustration and with no implied limitation.

FIG. 1 schematically represents a structure, in cross section, of a first variant of an electrical cable according to the invention.

FIG. 2 schematically represents a structure, in cross section, of a second variant of an electrical cable according to the invention.

FIG. 3 schematically represents a structure, in cross section, of a third variant of an electrical cable according to the invention.

FIG. 4 represents a scanning electron microscope (SEM) view of an alloy which is not part of the invention comprising aluminum, erbium, copper and iron.

FIG. 5 represents a scanning electron microscope (SEM) view of the alloy of the invention comprising aluminum, erbium, copper and iron.

### DETAILED DESCRIPTION

For reasons of clarity, the same elements have been denoted by identical references. Likewise, only the elements essential for understanding the invention have been represented schematically, and not to scale.

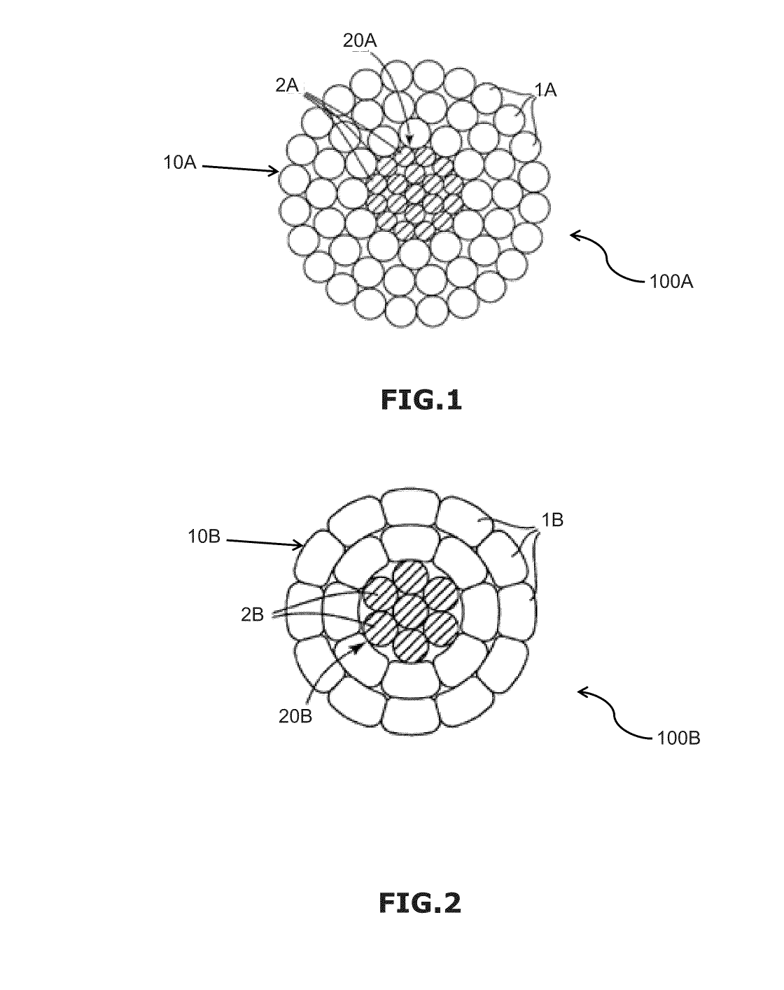

FIG. 1 represents a first variant of a high-voltage electric power transmission electrical cable of OHL type 100A according to the invention, seen in cross section, comprising an elongate electrically conductive element 10A composed of three layers of an assembly of metallic strands 1A of alloy of the invention. These three layers surround an elongate reinforcing central element 20A. The constituent metallic strands 1A of said layers have a round cross section.

FIG. 2 represents a second variant of a high-voltage electric power transmission electrical cable of OHL type 100B according to the invention, seen in cross section, comprising an elongate electrically conductive element 10B composed of two layers of an assembly of metallic strands 1B of alloy of the invention. These two layers surround an elongate reinforcing central element 20B. The constituent metallic strands 1B of said layers have a trapezoidal cross section.

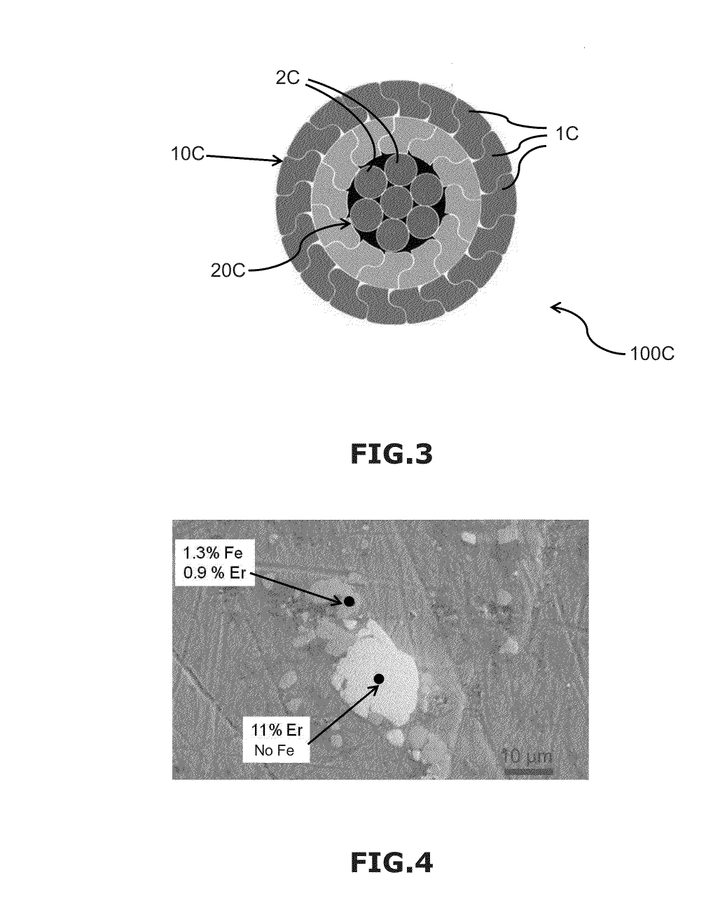

FIG. 3 represents a third variant of a high-voltage electric power transmission electrical cable of OHL type 100C according to the invention, seen in cross section, comprising an elongate electrically conductive element 10C composed of two layers of an assembly of metallic strands 1C of alloy of the invention. These two layers surround an elongate reinforcing central element 20C. The constituent metallic strands 1C of said layers have a Z-shaped (or S-shaped, depending on the orientation of the Z) cross section. The geometry of the Z-shaped strands makes it possible to obtain a surface that is virtually free of any interstices that may generate accumulations of moisture and therefore centers of corrosion.

The elongate reinforcing central element 20A, 20B, 20C represented in FIGS. 1, 2 and 3 may be for example steel strands 2A, 2B, 2C or composite strands 2A, 2B, 2C of aluminum in an organic matrix.

In embodiment variants represented in FIGS. 1 to 3, it is possible to modify the number of strands 1A, 1B, 1C of each layer, their shape, the number of layers or else the number of steel strands or composite strands 2A, 2B, 2C, and also the nature of the aluminum.

Comparative tests were carried out in order to demonstrate the electrical properties of the alloy according to the invention.

### Example 1

In order to do this, two alloys A1 and A2 of the invention were prepared according to the process of the invention in the following manner.

After having incorporated a master alloy of aluminum, erbium (the erbium not being in the form of precipitates), copper and iron, in a molten bath of pure aluminum at more than 98.9% by weight, everything is mixed in order to homogenize the pure aluminum and the master alloy, and to thus form a molten alloy (step i).

Next the molten alloy is cast in a cylindrical die in order to form a bar of an “as-cast” alloy, that is solidified by cooling on passing from a temperature of 670° C.-850° C. to a temperature of 150° C. in 1 min: the cylindrical bar formed has a diameter of 30 mm (step ii).

The cylindrical bar, directly formed in the preceding step, is hot-rolled in order to obtain a bar of smaller diameter, namely a bar having a diameter of 9.5 mm (step iii).

The bar from the preceding step is heated at 350° C. for 15 h in order to form erbium precipitates (step iv).

Finally, the heated bar from the preceding step is cold-drawn in order to obtain wires of alloy of the invention (i.e. metallic strands of alloy of the invention) having a diameter of 3 mm (step v).

Each of the alloys of the invention comprises at most 1.1% by weight of unavoidable impurities.

Table 1 below collates the erbium, copper and iron contents of each of the aluminum alloys A1 and A2 in accordance with the invention, and also the electrical conductivity of the alloy wires obtained.

Table 1 also includes four comparative alloys A01, A02, A03 and A04 that are not part of the invention since A01 does not comprise erbium, A02 does not comprise copper and iron, and A03 and A04 have not undergone a heating step in accordance with step iv of the process of the invention.

The alloy A01 is sold under the reference Al1120 by Nexans.

The alloy A02 is obtained according to the process described in CN 101418401 (process that does not comprise the steps iii and iv).

TABLE 1

| | Erbium | Copper | Iron | Heating | Electrical |
|---|---|---|---|---|---|
| | content | content | content | conditions | conductivity |
| Alloy | (in ppm) | (in ppm) | (in ppm) | of step iv | (% IACS) |
| A1 | 1000 | 1700 | 3000 | 350° C., 15 h | 61.1 |
| A2 | 3000 | 1700 | 3000 | 350° C., 15 h | 62.0 |
| A01 | — | 1700 | 3000 | — | 59.1 |
| A02 | 2000/4000 | — | — | — | 60.9/60.8 |
| A03 | 1000 | 1700 | 3000 | — | 58.7 |
| A04 | 3000 | 1700 | 3000 | — | 59.7 |

Thus, the presence of erbium in the alloy of the invention improves its electrical conductivity, especially owing to the heating step iv of the process of the invention which makes it possible to form sufficient erbium precipitates that have a controlled microstructure.

Furthermore, the addition of iron and copper makes it possible to maintain good electrical conductivity properties, or even to improve them, while obtaining better mechanical properties, especially in terms of hot creep resistance and breaking strength.

An alloy A05 not in accordance with the invention was prepared according to the process as described above, except that it did not undergo a heating step and it comprised 3000 ppm by weight of erbium, 1500 ppm by weight of copper and 2500 ppm by weight of iron. The alloy A05 is not part of the invention since it has not undergone a heating step in accordance with step iv of the process of the invention.

The appended FIG. 4 shows an SEM view of said alloy A05 (i.e. after the casting/solidification step ii). In this FIG. 4, it is possible to see, on the one hand, erbium precipitates with unavoidable impurities (11% erbium) and, on the other hand, erbium precipitates with iron (1.3% iron and 0.9% erbium).

These precipitates are primary precipitates that may be formed during the solidification. They are few in number, very coarse (i.e. they have a mean size ranging from 0.5 to 10 μm), and are not spherical unlike the secondary precipitates that would be formed if the alloy A05 underwent a heating step in accordance with step iv of the process of the invention.

An alloy A3 of the invention was prepared according to the process as described above, except as regards the heating step which was carried out at 350° C. for 2 hours, said alloy A3 comprising 3000 ppm by weight of erbium, 1700 ppm by weight of copper and 3000 ppm by weight of iron.

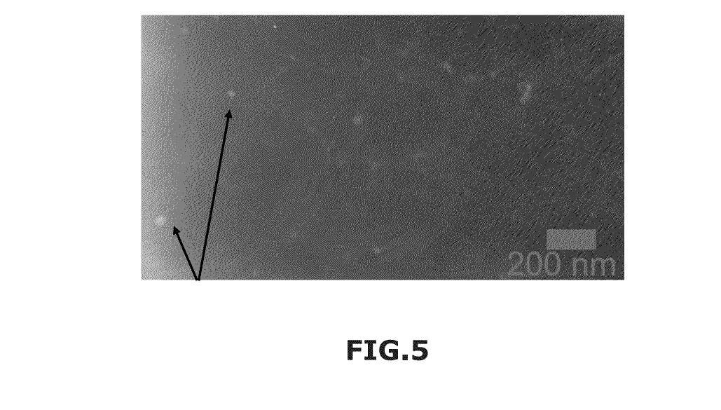

The appended FIG. 5 shows an SEM view of said alloy A3 after the heating step iv. The erbium precipitates obtained have a mean size of the order of 22 nm (i.e. formation of secondary precipitates) and are of spherical shape.

### Example 2

Two other alloys A4 and A5 of the invention were prepared according to the process of the invention and as described in Example 1.

Table 2 below collates the erbium, copper and iron contents of each of the aluminum alloys A4 and A5 in accordance with the invention, and also the electrical conductivity of the alloy wires obtained.

Table 2 also includes two comparative alloys A06 and A07 that are not part of the invention since A06 does not comprise erbium and A07 has not undergone a heating step in accordance with step iv of the process of the invention.

The alloy A06 is sold under the reference Al1350 by Nexans.

TABLE 2

| | Erbium | Copper | Iron | Heating | Electrical |
|---|---|---|---|---|---|
| | content | content | content | conditions | conductivity |
| Alloy | (in ppm) | (in ppm) | (in ppm) | of step iv | (% IACS) |
| A4 | 1000 | — | 1000 | 350° C., 2 h | 62.9 |
| A5 | 1000 | — | 1000 | 350° C., 15 h | 63.0 |
| A06 | — | — | 1000 | | 62.5 |
| A07 | 1000 | — | 1000 | | 61.2 |

Thus, the results from Table 2 show that the heating step iv is necessary to make it possible to maintain a good electrical conductivity of an alloy comprising erbium and iron.

1. Electrical cable comprising:
an elongate electrically conductive element made of aluminum alloy having aluminum (Al) and erbium precipitates (Al₃Er), wherein said aluminum alloy additionally has an element selected from the group consisting of iron (Fe), copper (Cu) and a mixture thereof; and unavoidable impurities.

2. Electrical cable according to claim 1, wherein the aluminum alloy has at least 100 ppm by weight of erbium.

3. Electrical cable according to claim 1, wherein the aluminum alloy has at most 10 000 ppm by weight of erbium.

4. Electrical cable according to claim 1, wherein the erbium precipitates (Al₃Er) have a mean size strictly smaller than 1 μm.

5. Electrical cable according to claim 1, wherein the erbium precipitates (Al₃Er) have a mean size ranging from 1 to 100 nm.

6. Electrical cable according to claim 1, wherein the aluminum alloy has from 1500 ppm to 4000 ppm by weight of iron.

7. Electrical cable according to claim 1, wherein the aluminum alloy has from 500 ppm to 3500 ppm by weight of copper.

8. Electrical cable according to claim 1, wherein the aluminum alloy has at least 98.00% by weight of aluminum.

9. Electrical cable according to claim 1, wherein the electrically conductive element has an assembly of metal strands.

10. Electrical cable according to claim 1, wherein said cable additionally comprises an elongate reinforcing element.

11. Electrical cable according to claim 10, wherein the elongate reinforcing element is surrounded by said elongate electrically conductive element made of aluminum alloy.

12. Electrical cable according to claim 10, wherein the elongate electrically conductive element made of aluminum alloy is twisted around the elongate reinforcing element.

13. Electrical cable according to claim 1, wherein said cable is an overhead energy transmission cable (OHL cable).

14. Process for manufacturing an aluminum alloy of aluminum (Al) and erbium precipitates (Al₃Er), said process comprising the following steps:
i. forming a molten aluminum alloy having aluminum; erbium; unavoidable impurities; and optionally an element selected from the group of iron (Fe), copper (Cu) and a mixture thereof;
ii. casting the molten alloy from step i, in order to obtain an as-cast alloy;
wherein said process additionally comprising the following steps:
iii. rolling the as-cast alloy from step ii, in order to obtain a rolled alloy; and
iv. heating the rolled alloy from step iii, in order to form erbium precipitates.

15. Process according to claim 14, wherein said process further comprises, after step iv, the following step:
v. cold-working the heated alloy from step iv, in order to obtain a cold-worked alloy.

16. Process according to claim 15, wherein said process further comprises, after step v, the following step:
vi. heating the alloy from step v, in order to increase the mechanical elongation of the alloy.

17. Process for manufacturing an electrical cable according to claim 10, wherein said process comprises the following steps:
a. manufacturing an aluminum alloy of aluminum (Al) and erbium precipitates (Al₃Er), said process comprising the following steps:
i. forming a molten aluminum alloy having aluminum; erbium; unavoidable impurities; and optionally an element selected from the group of iron (Fe), copper (Cu) and a mixture thereof;
ii. casting the molten alloy from step i, in order to obtain an as-cast alloy;
wherein said process additionally comprising the following steps:
iii. rolling the as-cast alloy from step ii, in order to obtain a rolled alloy; and
iv. heating the rolled alloy from step iii, in order to form erbium precipitates,
said steps obtaining said elongate electrically conductive element made of aluminum alloy, and
b. positioning said elongate electrically conductive element obtained in step a, around the elongate reinforcing element, in order to form the electrical cable.
